(19) United States
(12) Patent Application Publication
(10) Pub. No.: US 2015/0139840 A1
(43) Pub. Date: May 21, 2015

(54) VALVE DEVICE FOR A HYDRAULIC CIRCUIT, AND OIL PUMP CONTROL ASSEMBLY

(71) Applicant: PIERBURG GMBH, NEUSS (DE)

(72) Inventors: Rolf Lappan, Koeln (DE); Christoph Sadowski, Sprockhoevel (DE); Lukas Romanowski, Osnabrueck (DE); Turgut Yilmaz, Koeln (DE)

(73) Assignee: PIERBURG GMBH, NEUSSS (DE)

(21) Appl. No.: 14/402,689

(22) PCT Filed: Apr. 29, 2013
(86) PCT No.: PCT/EP2013/058885

§ 371 Date: Nov. 21, 2014

(30) Foreign Application Priority Data
May 23, 2012 (DE) 10 2012 104 456.2

(51) Int. Cl. F04C 14/24; F16K 1/44; F16K 11/24; F16K 31/06; F04C 2/24; F16K 15/18

(52) U.S. Cl. CPC F04C 14/24; F04C 2/24; F16K 15/183; F16K 11/24; F16K 31/0631; F16K 1/443
USPC 418/16; 137/614.2

(57) ABSTRACT

A valve device for a hydraulic circuit includes an actuator unit and a valve unit. The actuator unit comprises a spring element and an electromagnetic circuit. The electromagnetic circuit comprises an armature, a core comprising a passage hole, a coil, and a flux-guiding device. A stop element comprising a passage opening is arranged in the passage hole so that a gap exists between the core and the armature when actuating the actuator unit. The valve unit comprises a first opening, a second opening, a third opening formed opposite the actuator unit, a first valve seat between the first and second opening, a second valve seat formed between the first and third opening, a first valve closure body connected to the armature and loaded by the spring element, and a second valve closing body loaded by hydraulic pressure and lifted from the second valve seat by the first valve closure body.

### CROSS REFERENCE TO PRIOR APPLICATIONS

This application is a U.S. National Phase application under 35 U.S.C. §371 of International Application No. PCT/EP2013/058885, filed on Apr. 29, 2013 and which claims benefit to German Patent Application No. 10 2012 104 456.2, filed on May 23, 2012. The International Application was published in German on Nov. 28, 2013 as WO 2013/174624 A1 under PCT Article 21(2).

### FIELD

The present invention relates to a valve device for a hydraulic circuit, comprising an actuator unit having an electromagnetic circuit with a translationally movable armature, a core with a passage hole, an energizable coil and flux guiding means, a valve unit with a first opening, a second opening serving as an outlet, and a first valve closure body connected with the armature and loaded by a spring element in the direction of a valve seat arranged between the first opening and the second opening, a third opening formed at the end of the valve unit opposite the actuator unit, and a second valve closure body biased by hydraulic pressure in the direction of a second valve seat formed between the first opening and the third opening, the second valve closure body being adapted to be lifted off the second valve seat by means of the first valve closure body, as well as an oil pump control assembly having such a valve device, a variable oil pump with a control chamber and an oil pan.

### BACKGROUND

Such valve devices serve the purpose of controlling the pressure of hydraulic actuators, for example, in controls for automatic transmissions, or the purpose of controlling the pressure in a control chamber of a variable oil pump of an oil circuit for the lubrication of an internal combustion engine of a motor vehicle. Through the pressure in the control chamber, a ring of a pump chamber, on which the rotor of a vane or gear pump rolls, is shifted or turned, whereby the delivery volume is changed.

The pressure control valves used for these purposes are designed as multiport solenoid valves by means of which it is possible either to relieve the pump control chamber via the oil pan or to charge it with additional pressure from the delivery pressure of the oil pump. Pressure relief valves are often also installed in the control circuit which limit the maximum delivery pressure.

Such a system for controlling the pressure in two control chambers of an oil pump with a solenoid valve is described, for example, in DE 11 2008 000 978 T5 where the differential pressure between the two control chambers is changed dependent on the delivery pressure and the position of the solenoid valve. This system additionally comprises a pressure relief valve via which oil can be returned from the pressure side of the pump to the suction side if the delivery pressure is too high. The use of an additional pressure relief valve is here disadvantageous.

A solenoid valve in which the pressure relief valve function is integrated is described in DE 103 30 779 A1. DE 103 30 779 A1 comprises an electromagnetically actuable valve element governing a flow cross section between a control port and an outlet via a translational movement of an armature of the solenoid, which is connected with a valve closure element and is biased by a spring element. The valve additionally comprises a spring-loaded ball as a second closure body between an inlet port and the control port. A plate with protrusions is provided between the armature and the core in order to avoid a large-surface abutment of the armature on the core in the solenoid.

This valve has the disadvantage, however, that the additional plate must be manufactured and installed in the interest of avoiding excessive required electromagnetic forces. This results in a complex assembly, specifically for the fixation of the plate in the valve, and a complicated manufacture of the plate with the protrusions. A rather strong spring thus must be used to release the armature, making it necessary to also provide for an additional oppositely-directed spring force below the ball for the safety function.

### SUMMARY

An aspect of the present invention is to provide a valve device in which the functions of opening at excessive pressure and of pressure control are combined in one valve device, wherein the valve device is intended to be operated in a manner largely independent of the required excessive pressure using small actuating forces and, thus, solenoids. An additional aspect of the present invention is to reduce the number of components and, if possible, to facilitate assembly.

In an embodiment, the present invention provides a valve device for a hydraulic circuit which includes an actuator unit and a valve unit. The actuator unit comprises a spring element and an electromagnetic circuit. The electromagnetic circuit comprises an armature configured to be translationally movable, a core comprising a passage hole, a coil configured to be energizable, and a device configured to guide a flux. A cylindrical stop element comprising a passage opening configured to extend in an extension direction is arranged in the passage hole so that a gap exists between the core and the armature when the actuator unit is actuated. The valve unit comprises a first opening, a second opening configured as an outlet, a third opening formed at an end of the valve unit opposite to the actuator unit, a first valve seat arranged between the first opening and the second opening, a second valve seat formed between the first opening and the third opening, a first valve closure body connected to the armature and configured to be loaded by the spring element in a direction of the first valve seat, and a second valve closing body configured to be loaded by a hydraulic pressure in a direction of the second valve seat and to be lifted from the second valve seat by the first valve closure body.

### BRIEF DESCRIPTION OF THE DRAWINGS

The present invention is described in greater detail below on the basis of embodiments and of the drawing in which:

FIG. 1 shows a side elevational view of a valve device of the present invention, shown in section with a schematically illustrated connection to an oil circuit of an internal combustion engine.

### DETAILED DESCRIPTION

Due to the fact that a cylindrical stop element having a passage opening extending in the extension direction is arranged in the passage hole of the core so that a gap exists between the core and the armature when the actuator unit is operated, small contact surfaces with small magnetic forces are formed so that smaller spring forces are sufficient to release the armature. It is accordingly also possible to omit the spring below the second closure body. The stop element can be assembled with the core, and the armature can be assembled with the first valve closure body, so that additional assembly steps are omitted. When the valve is used, the first opening is connected with the control chamber of the oil pump, the second opening is connected with the oil pan, and the third opening is loaded by the delivery pressure of the oil pump. It is thus possible to perform a full delivery pressure control via the valve and, at the same time, an excessive delivery pressure can be avoided by means of the valve without requiring an additional pressure relief valve.

In an embodiment of the present invention, the stop element can, for example, be designed as a hollow cylinder. Such sleeves are low-cost standardized parts so that manufacturing costs are reduced. A simple assembly of the sleeve in the passage hole of the core is achieved at the same time.

In an embodiment of the present invention, a ball can, for example, be used as a second valve closure body. A ball is available as a standardized component at low cost. The requirements regarding the precision of the components are also reduced due to this two-part design.

In an embodiment of the present invention, the passage hole of the core can, for example, have a shoulder against which the spring element abuts that surrounds the stop element in the portion direction towards the armature. With little structural space required, the spring force can thus act directly against the armature, wherein the stop element provides for an inner spring guiding and, at the same time, the core provides an outer spring guiding.

In an embodiment of the present invention, the first valve closure body is formed conically at the end directed towards the first valve seat, and a pin extends from the first valve closure body through the first valve seat towards the second valve closure body. This component can be manufactured in a simple manner as a turned part. The conical valve closure body provides for a tight closure, while the pin urges the ball into the releasing position.

In an embodiment of the present invention, the armature can, for example, be formed integrally with the valve closure body so that additional assembly steps can be omitted.

In an embodiment of the present invention, the valve closure body can, for example, be pressed into a hole in the armature. This facilitates the manufacture of the individual parts, wherein a total length can be adjusted by pressing in the valve closure body.

In an embodiment of the present invention, the stop element can, for example, also be pressed into the passage hole of the core. The stop forces occurring can be absorbed without problems via this press-fit connection making it possible to use this connection which is particularly economic and easy to manufacture.

In an embodiment of the present invention, the armature slides in a housing part in which a housing of the valve unit is arranged at the opposite end, the two valve seats being formed in the latter housing. It is thus possible to integrate all ports and valve seats in only two components which can be connected via a simple plugging operation. It is also possible to provide a translational height adjustment between the valve closure body and the valve seat. The components can accordingly be manufactured with relatively great tolerances.

In a development of the above embodiment of the present invention, the second opening is formed in the housing part. The housing of the valve unit therefore ends before the outlet of the solenoid valve. The opening can be formed immediately during manufacture so that no further manufacturing steps are needed.

A valve device is thus provided that combines the functions of a pressure relief valve and a pressure control valve. The necessary electromagnetic actuating forces can be kept low via a correct design of the spring, whereby use can be made of a standard coil. The individual components are easy to assemble, it being possible to combine some components into pre-assembly units. A small number of components is used, with most components being manufactured at low cost in large quantities as standardized parts. It is accordingly possible to perform an oil pump control with a fast adjustment of the quantity of oil to be delivered, with a failsafe function additionally being provided.

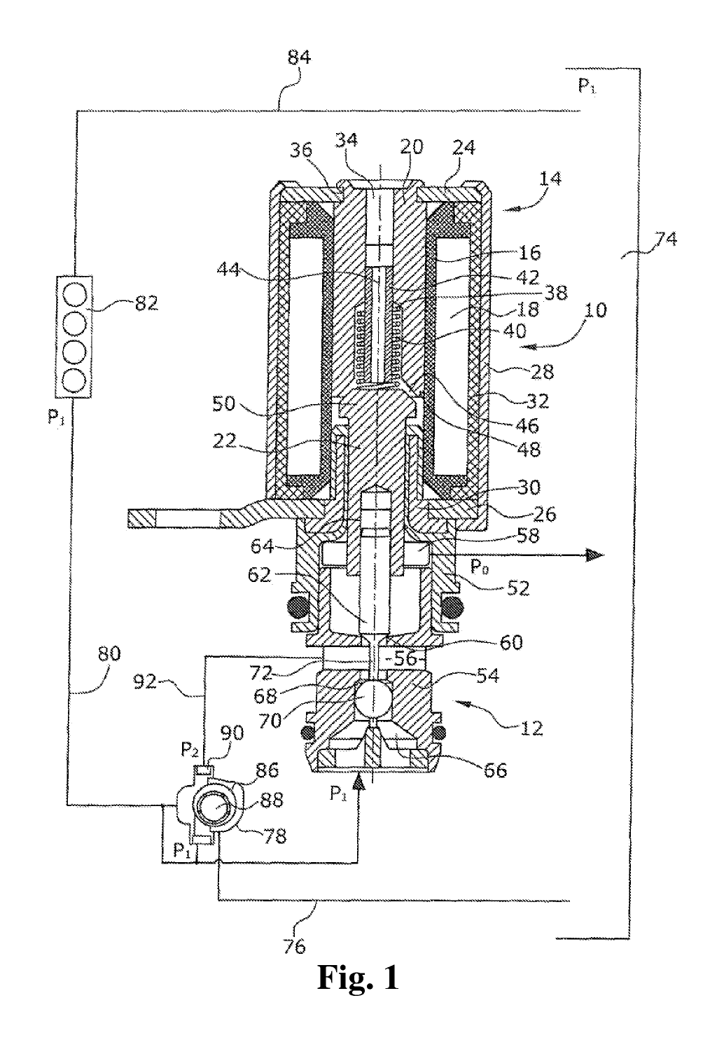

An embodiment of a valve device according to the present invention and of the associated oil pump control assembly is illustrated in FIG. 1 and will be described hereunder.

The valve device of the present invention illustrated in FIG. 1 comprises and actuator unit 10 to which a valve unit 12 is fastened. The actuator unit 10 comprises an electromagnetic circuit 14 formed by a coil 18 wound on a coil carrier 16, a core 20 inside the coil carrier 16, a translationally movable armature 22 and flux guiding means completing the electromagnetic circuit 14. The flux guiding means consist of an upper inference plate 24 and a lower interference plate 26 arranged at the axial ends of the coil 18 and connected with a yoke 28 surrounding the coil 18 on the outer side, as well as a further flux guiding element 30 extending into the coil 18 and connected with the lower inference plate 26. The coil 18 is surrounded by a plastic material jacket 32 which further comprises a plug member (not illustrated) for the supply of power to the coil 18.

The core 20 has an axially extending passage hole 34 and is fastened in the coil carrier 16. At its end averted from the valve unit 12, the core 20 has a circumferential recess 36 into which the upper inference plate 24 protrudes circumferentially for being fastened.

A shoulder 38 is formed in the passage hole 34 on the side of the passage hole 34 facing toward the valve unit 12, against which shoulder a spring element 40 abuts whose opposite end is prestressed to contact the armature 22. A stop element 42 with an axially extending passage opening 44, which in the present embodiment is a hollow cylinder, is situated in the passage hole 34, the stop element 42 being fastened by a press-fitting connection in the smaller diameter region of the passage hole 34 and extending into the larger diameter region, so that this region of the stop element 42 is radially surrounded by the spring element 40. The stop element 42 is arranged in passage hole 34 so that it limits the movement of the armature. This means that an abutment of the armature 22 on the core 20 is avoided and a gap 46 also remains in the attracted state of the armature 22.

When the coil 18 is energized, a magnetic force of attraction is generated between the armature 22 and the core 20 which comprises a pointed protrusion 48 for concentrating the axially extending magnetic flux lines, a correspondingly shaped frustoconical part 50 of the armature 22 plunging into the interior of the projection when the coil 18 is energized.

The armature 22 is guided in a housing part 52 that surrounds the flux guiding element 30 in the region of the armature guiding and extends as a hollow cylinder with its larger diameter directed towards the valve unit 12. In the region of the lower inference plate 26, the flux guiding element 30 protrudes from the surrounding housing part 52 to form a conductive connection with the lower inference plate 26.

The hollow cylindrical portion of the housing part 52, which extends towards the valve unit 12, serves to receive a housing 54 of the valve unit 12, in which a first opening 56 is formed, which can be connected fluidically with a second opening 58, which is formed in the housing part 52 between the valve unit 12 and the actuator unit 10, via a flow cross section in the housing 54 surrounded by a first valve seat 60 on which a first valve closure body 62 can be set or from which the first valve closure body 62 can be lifted, and which is thus arranged between the first opening 56 and the second opening 58.

The valve seat 60 is shaped as a truncated cone and cooperates with a frustoconical portion of the valve closure body 62, the inclination of the truncated cone walls being steeper than the inclination of the conical first valve seat 60 so that a linear contact results in the closed state. The first valve closure body 62 is pressed into a central axial bore 64 in the armature 22.

The housing 54 has a third opening 66 extending in the axial direction from the end of the housing 54 averted from the actuator unit 10 towards the first radially extending first opening 56. A second valve seat 68 is further formed in the flow cross section between the first opening 56 and the third opening 66 of the housing 54, on which second valve seat 68 a second valve closure body 70 can be set or from which the second valve closure body 70 can be lifted, the second valve closure body 70 being provided as a ball. Lifting the ball 70 from the second valve seat 68 is effected by means of a pin 72 that extends from the first valve closure body 62 through the flow cross section surrounded by the first valve seat 60 to the flow cross section surrounded by the second valve seat 68.

The functioning of the valve device as an oil pump control will be described hereunder with reference to the oil circuit of an internal combustion engine.

The oil circuit is formed by an oil pan 74 from which oil is drawn by a variable oil pump 78 via a suction line 76. This oil flows through a feed line 80 to an internal combustion engine 82 to lubricate the internal combustion engine 82 and flows from the internal combustion engine 82 back to the oil pan 74 via a return line 84.

As mentioned above, the oil pump 78 is not a pump that continuously delivers the same delivery volume, but a pump that is adjustable with respect to the delivery volume, and thus the delivery pressure p₁, by adjustment of an eccentric ring 86 in which a pump rotor 88 is eccentrically rotated for delivery.

The adjustment of the eccentric ring 86 is effected by controlling a control pressure p₂ in a control chamber 90 of the oil pump 78. The control pressure p₂ acting in the control chamber 90 is controlled via the valve device of the present invention by connecting the first opening 56 of the valve device with the control chamber 90 via a control line 92 so that the same pressure p₂ always prevails at the first opening 56 of the valve and in the control chamber 90. On the opposite side of the eccentric ring 86, the respective delivery pressure p₁ of the oil pump 78 is active. The second opening 58 of the valve serves as an outlet to the oil pan 74.

In the non-energized state of the valve, the armature 22, and thus the first valve closure body 62, is pressed onto the first valve seat 60 by the pressing force of the spring element 40. The fluidic connection between the first opening 56 and the second opening 58 is correspondingly closed. In this state, the pin 72 formed on the valve closure body 72 simultaneously pushes the ball 70 from the second valve seat 68 so that a connection between the first opening 56 and the third opening 66 is established. A control pressure p₂ is thus generated that builds up to a maximum delivery pressure p_{1/max} in the control chamber 90 since the eccentric ring 86 is shifted ever further towards the maximum delivery pressure.

Besides the force of the spring element 40, a counter-pressure acts on the armature 22 via the first valve closure body 62, or the control surface thereof arranged inside the first valve seat 60, the counter-pressure corresponding to the control pressure p₂. When the control pressure p₂ reaches a certain value p_{safe}, the armature 22 is shifted towards the core 20 via the control surface, whereby on the one hand, the connection between the third opening 66 and the first opening 56 is closed and, on the other hand, the connection between the first opening 56 and the second opening 58 is opened. Oil can therefore flow from the control chamber 90 into the oil pan 74. The eccentric 86 is thus shifted so that the delivery pressure of the pump decreases. The delivery pressure is thereby limited to a maximum pressure adjustable through the spring force. A failsafe function is available in this manner in case of a failure of the actuator unit 10.

When it is intended to reduce the delivery pressure p₁, voltage is supplied to the coil 18 via the control. As a result, the armature 22 is pulled towards the core 20 so that the first valve closure body 62 is lifted from the first valve seat 60 and a connection is established between the first opening 56 and the second opening 58, whereby the control pressure p₂ in the control chamber 90 and, thereby, the delivery pressure p₁ is reduced, since oil can flow from the control chamber 90 towards the oil pan 74 and, on the other hand, the ball 70 is pressed on the valve seat 68 so that the connection to the delivery pressure port is closed.

When the solenoid is operated or in the event of a failsafe activation, no or only small hydraulic forces occur in the closing direction by the movement of the armature 22 since the oil present in the space between the armature 22 and the core 20 can flow out through the passage opening 44 and the passage hole 34 so that this oil is not compressed.

When the coil 18 is energized, the stop element 42 also prevents a large-surface contact of the armature 22 with the core 20, as well as cohesion forces entailed thereby, which forces could cause the valve to stay in the state clearing the connection with the oil pan at the time the power supply to the coil 18 is ended. This could be prevented only by particularly great spring forces which would, however, require correspondingly great electromagnetic forces for opening. This is reliably prevented by the small contact surface of the armature 22 on the stop element 42 so that a small standard coil is sufficient to actuate the valve device of the present invention. This valve device is easy and economic to manufacture and to assemble, especially because of the use of standardized components and pre-assembled sets like the core with the stop element or the armature with the valve closure body.

It should be clear that these valve devices are also suited for use in other hydraulic circuits. Design changes of the valve device with respect to the embodiment illustrated, such as, for example, an integral design of the armature, the valve closure body and the valve plunger, or a different division of the housings and the like, are also conceivable. The passage opening in the stop element can, for example, also be designed as a lateral notch or the like, instead of as a hole. Reference should be had to the appended claims.

What is claimed is:

1-11. (canceled)

12. A valve device for a hydraulic circuit, the valve device comprising:
an actuator unit comprising,
a spring element, and
an electromagnetic circuit comprising,
an armature configured to be translationally movable,
a core comprising a passage hole, a cylindrical stop element comprising
a passage opening configured to extend in an extension direction being arranged in the passage hole so that a gap exists between the core and the armature when the actuator unit is actuated,
a coil configured to be energizable, and
a device configured to guide a flux; and
a valve unit comprising,
a first opening,
a second opening configured as an outlet,
a third opening formed at an end of the valve unit opposite to the actuator unit,
a first valve seat arranged between the first opening and the second opening,
a second valve seat formed between the first opening and the third opening,
a first valve closure body connected to the armature and configured to be loaded by the spring element in a direction of the first valve seat, and
a second valve closing body configured to be loaded by a hydraulic pressure in a direction of the second valve seat and to be lifted from the second valve seat by the first valve closure body.

13. The valve device as recited in claim 12, wherein the cylindrical stop element is provided as a hollow cylinder.

14. The valve device as recited in claim 12, wherein the second valve closure body is a ball.

15. The valve device as recited in claim 12, wherein the passage hole of the core comprises a shoulder, the spring element being configured to abut against the shoulder and to radially surround the stop element in a region directed towards the armature.

16. The valve device as recited in claim 12, wherein the first valve closure body is provided as a shape of a cone at an end directed towards the first valve seat, and further comprising a pin configured to extend from the first valve closure body through the first valve seat towards the second valve closure body.

17. The valve device as recited in claim 12, wherein the armature is formed integrally with the first valve closure body.

18. The valve device as recited in claim 12, wherein the armature comprises a bore, and the first valve closure body is press-fitted in the bore.

19. The valve device as recited in claim 12, wherein the cylindrical stop element is press-fitted in the passage hole of the core.

20. The valve device as recited in claim 12, further comprising a housing part configured to have the armature slide therein, the housing part comprising a housing of the valve unit arranged at an opposite end, each of the first valve seat and the second valve seat being formed in the housing.

21. The valve device as recited in claim 20, wherein the second opening is formed in the housing part.

22. An oil pump control assembly comprising:
the valve device as recited in claim 12; and
a variable oil pump comprising a control chamber and an oil pan,
wherein,
the first opening is connected with the control chamber of the variable oil pump,
the second opening is connected with the oil pan, and
the third opening is configured to be loaded by a delivery pressure of the variable oil pump.
